(19) United States
(12) Patent Application Publication
(10) Pub. No.: US 2023/0090616 A1
(43) Pub. Date: Mar. 23, 2023

(54) LEARNING SYSTEM, APPARATUS AND METHOD

(71) Applicant: KABUSHIKI KAISHA TOSHIBA, Tokyo (JP)

(72) Inventors: Shuhei NITTA, Tokyo (JP); Atsushi YAGUCHI, Tokyo (JP); Akiyuki TANIZAWA, Kawasaki (JP)

(73) Assignee: KABUSHIKI KAISHA TOSHIBA, Tokyo (JP)

(21) Appl. No.: 17/652,118

(22) Filed: Feb. 23, 2022

(30) Foreign Application Priority Data
Sep. 15, 2021 (JP) 2021-150348

(51) Int. Cl. G06N 20/00

(52) U.S. Cl. CPC G06N 20/00

(57) ABSTRACT

According to one embodiment, a learning system includes a plurality of local devices and a server. Each of the local devices includes a processor. The processor of the local device selects a first parameter set from a plurality of parameters related to the local model, and transmits the first parameter set to the server. At least one of the local devices is different from other local devices in a size of the local model in accordance with a resolution of input data. The server comprises a processor. The processor of the server integrates first parameter sets acquired from the local devices and update a global model. The processor of the server transmits the second parameter set to a local device that has transmitted the corresponding first parameter set.

This application is based upon and claims the benefit of priority from Japanese Patent Application No. 2021-150348, filed Sep. 15, 2021, the entire contents of which are incorporated herein by reference.

### FIELD

Embodiments described herein relate to a learning system, apparatus and method.

### BACKGROUND

Machine learning models (local models) are trained based on training data acquired by each of a plurality of devices, and parameters of the trained local models are transmitted to a server. In the server, the parameters of each local model are aggregated and integrated, and a machine learning model (global model) existing in the server is updated. Parameters of the updated global model are distributed to each of the plurality of devices. There is a training method called federated learning that repeats such a series of processes.

In the federated learning, training is performed by a plurality of devices, so that a calculation load can be distributed. Furthermore, since only the parameters are exchanged with the server, there is no exchange of the training data itself. Therefore, there is an advantage that privacy confidentiality is high and communication cost is low. However, in a case where data sizes, computer resources, and required specifications are different in a plurality of devices, it is difficult to implement the federated learning.

### BRIEF DESCRIPTION OF THE DRAWINGS

FIG. 1 is a conceptual diagram illustrating an example of an implementation environment of federated learning in a learning system according to the present embodiment;

FIG. 2 is a block diagram illustrating a local device according to a first embodiment;

FIG. 3 is a block diagram illustrating a server according to the first embodiment;

FIG. 4 is a flowchart illustrating a training process by a learning system according to the first embodiment;

FIG. 5 is a diagram illustrating an example of correspondence relationships between local models and a global model;

FIG. 6 is a block diagram illustrating a server according to a second embodiment;

FIG. 7 is a flowchart illustrating a training process by a learning system according to the second embodiment;

FIG. 8 is a block diagram illustrating a server according to a third embodiment;

FIG. 9 is a flowchart illustrating a case presentation process by the server according to the third embodiment;

FIG. 10 is a block diagram illustrating a server according to a fourth embodiment;

FIG. 11 is a flowchart illustrating a determination process by the server according to the fourth embodiment; and

FIG. 12 is a block diagram illustrating an example of a hardware configuration of each of a local device and a server.

### DETAILED DESCRIPTION

In general, according to one embodiment, a learning system includes a plurality of local devices and a server. Each of the local devices includes a processor. The processor of a local device trains a local model by using local data. The processor of the local device selects a first parameter set from a plurality of parameters related to the local model. The processor of the local device transmits the first parameter set to the server. At least one of the local devices is different from other local devices in a size of the local model in accordance with a resolution of input data. The server comprises a processor. The processor of the server integrates first parameter sets acquired from the local devices and update a global model. The processor of the server selects each second parameter set corresponding to each of the first parameter sets from among a plurality of parameters related to the global model. The processor of the server transmits the second parameter set to a local device that has transmitted the corresponding first parameter set.

Hereinafter, a learning system, apparatus and method according to the present embodiment will be described in detail with reference to the drawings. Note that, in the following embodiments, portions denoted by the same reference numerals perform the same operation, and redundant description will be appropriately omitted.

### First Embodiment

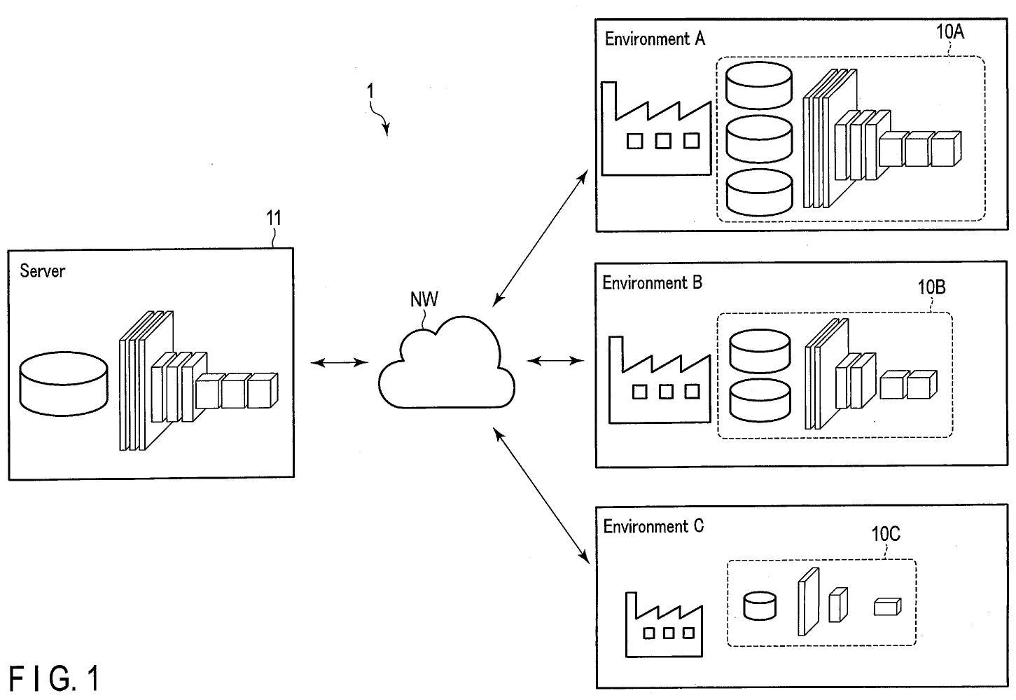

An example of an implementation environment of federated learning assumed in the learning system according to the present embodiment will be described with reference to a conceptual diagram of FIG. 1.

As illustrated in FIG. 1, a learning system 1 assumed in the present embodiment includes a plurality of local devices and a server 11. In the example of FIG. 1, it is assumed that environments in which each local device is used are different in an environment A, an environment B, and an environment C. Specifically, factories having different scales are assumed. That is, the environment A is a large-scale factory, and the local device 10A is used in the environment A. The environment B is a medium-scale factory, and the local device 10B is used in the environment B. The environment C is a small-scale factory, and the local device 10C is used in the environment C. Note that the environments in which the local devices are placed are not limited to the factories, and may be groups such as hospitals, schools, and homes. Hereinafter, for convenience of description, in the description common to the respective local devices 10A to 10C, the local devices are simply referred to as local devices 10. The plurality of local devices 10 and the server 11 are connected to each other via a network NW so as to be able to transmit and receive data to and from each other.

Each of the plurality of local devices 10 includes a neural network model (hereinafter, referred to as a local model) that shares some of parameters with a scalable neural network, while the parameters and the scalable neural network are included in the server 11 to be described later. The scalable neural network is a neural network that varies a model size such as the number of convolution layers of a network model according to a required operation amount or performance. Each of the plurality of local devices 10 trains the local model using manufacturing data generated and acquired in each of the environments as training data. Each of the local devices 10 may be any device on which a processing circuit for performing training is mounted, and is assumed to be a PC, a workstation, a tablet PC, a smartphone, a microcomputer, or the like. Further, the processing circuit may be any processing circuit such as a central processing unit (CPU), a graphics processing unit (GPU), field programmable gate array (FPGA) or an application specific integrated circuit (ASIC).

Specifically, each local device 10 uses inspection images of a manufactured product of the factory as training data to train the local model related to a classification task of classifying the inspection images into a non-defective product and a defective product. Each local device 10 executes inference on the target data using the trained local model, and executes classification between non-defective products and defective products in each environment. Note that the task of the local model is not limited to the classification task, and may be any task such as object detection, semantic segmentation, motion recognition, abnormality detection, and suspicious person detection. In addition, the training data and input data for the execution of the trained local model are not limited to the images, and may be time-series data such as an operation sound such as a voice and a machine sound, an environmental sound, acceleration data, and meter data, and may be any data.

Note that, in the example of FIG. 1, it is assumed that three types of the three local devices 10 are different based on the scale of the environments. The number of types is not limited to three, and may be two or four or more. As a condition of the local devices 10, at least one of the plurality of local devices 10 may be different from the other local devices 10 in at least one of training data, the computer scale, and the local models. In the example of FIG. 1, the local device 10A used in the environment A is larger in training data and computer scale than the local device 10 C used in the environment C. In a case where the training data is different, it indicates that the number of pieces of training data, the resolution of the data, and the number of categories are different. For example, when the input data is inspection images, it indicates that the number of inspection images, the image sizes (resolution), the number of categories of defective products to be classified, and the like are different.

When the local models are different, it indicates that the model structures and the model sizes, the number of parameters such as weights and biases, and the like are different. Furthermore, in a case where the computer scale (specifications) is different, it indicates that, for example, specifications of general-purpose GPUs (GPGPUs) and the CPUs are different in each of the local devices 10.

The server 11 includes the scalable neural network (hereinafter, the scalable neural network held in the server 11 is referred to as a global model). The server 11 updates parameters of the global model, and transmits the parameters according to the scale of each local model to each local device 10. The global model is assumed to be greater than or equal to the maximum size among the local models used by the plurality of local devices 10.

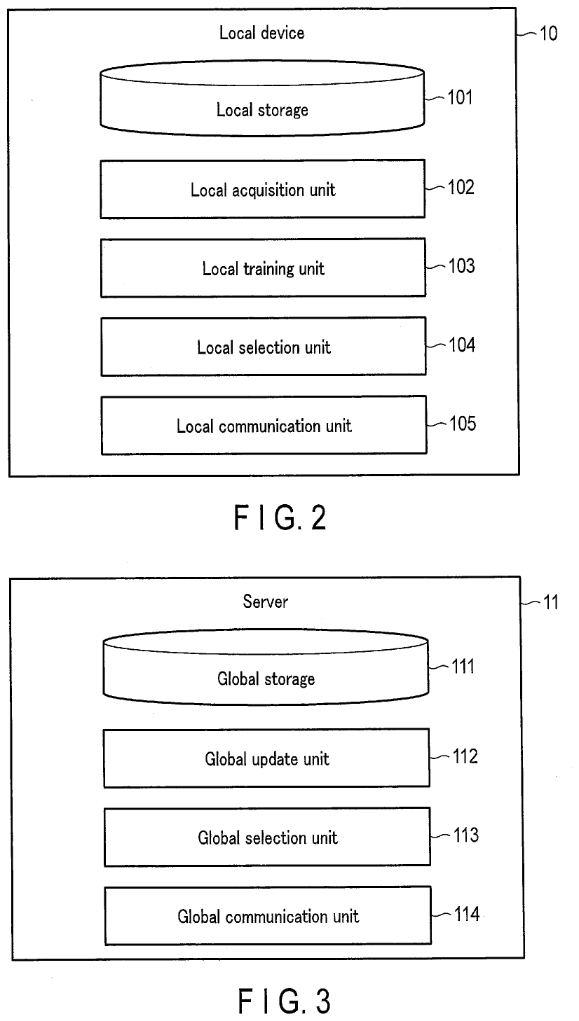

Next, the local devices 10 according to the first embodiment will be described with reference to a block diagram of FIG. 2.

The local device 10 includes a local storage 101, a local acquisition unit 102, a local training unit 103, a local selection unit 104, and a local communication unit 105.

The local storage 101 stores local data and a local model.

The local acquisition unit 102 acquires training data by sampling the training data from the local data. The local training unit 103 uses the local data to train the local model.

The local selection unit 104 selects a first parameter set to be transmitted to the server 11 from among a plurality of parameters related to the local model. Specifically, the first parameter set is a subset of parameters (such as a weighting factor and a bias) of the neural network for sharing the parameters with the global model.

The local communication unit 105 transmits the first parameter set to the server 11 and receives a second parameter set transmitted from the server 11.

Next, the server 11 according to the first embodiment will be described with reference to a block diagram of FIG. 3.

The server 11 according to the first embodiment includes a global storage 111, a global update unit 112, a global selection unit 113, and a global communication unit 114.

The global storage 111 stores the global model.

The global update unit 112 integrates the respective first parameter sets received from the plurality of local devices 10 and updates the global model.

The global selection unit 113 selects a second parameter set corresponding to each of the first parameter sets from a plurality of parameters related to the updated global model.

The global communication unit 114 receives each of the first parameter sets from the plurality of local devices 10. The global communication unit 114 transmits the second parameter sets selected by the global selection unit 113 to the local devices 10 that have transmitted the corresponding first parameter sets. Note that the network model related to each of the local models and the global model assumed in the present embodiment is assumed to be a convolutional neural network including an intermediate layer. Note that the network model is not limited thereto, and any network model may be used according to tasks of the local models as long as the network model has a model structure used in general machine learning, such as a multilayer perceptron (MLP), a recurrent neural network (RNN), a transformer, or a BERT (Bidirectional Encoder Representations from Transformer).

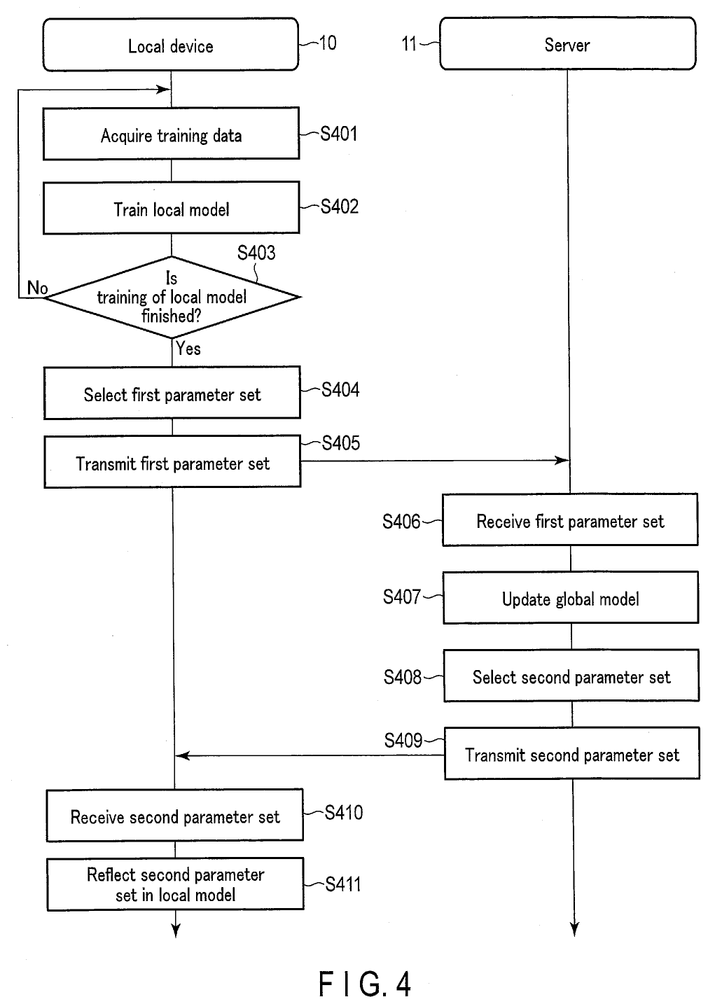

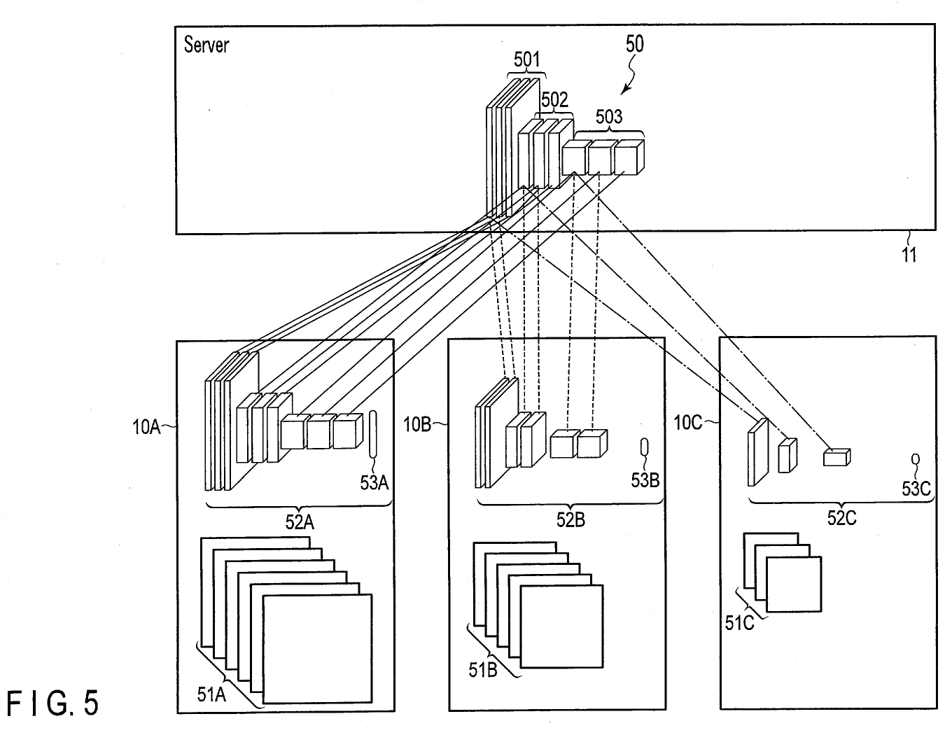

Next, a training process of the learning system 1 according to the first embodiment will be described with reference to a sequence diagram of FIG. 4.

In step S401, the local acquisition unit 102 of each local device 10 acquires training data. In this case, it is assumed that an input image x→ᵢⱼ is acquired as the training data. The superscript arrow indicates that a target to which the arrow is given is tensor data. The subscript i is a serial number of the environment, and is represented as i=1 (environment A), i=2 (environment B), and i=3 (environment C) in the example of FIG. 1. The subscript j is a serial number of the training data and is represented by j=1, . . . , Nᵢ. Nᵢ is a natural number of 2 or more, representing the number of pieces of training data acquired in the environment i. In addition, the input image x→ᵢⱼ is a pixel set having a horizontal width Wi and a vertical width Hi, and is two-dimensional tensor data. The image size (resolution) and the number of input images may vary depending on the local device.

A target label for the input image x→ᵢⱼ is represented as t→ᵢⱼ . The target label t→ᵢⱼ is an Mᵢ-dimensional vector in which a corresponding element is 1 and the other elements are zero. Mᵢ is the number of classification types required for the environment i, and is a natural number of two or more. Mᵢ assumes that different local devices have different environments. For example, it is assumed that Mi is a larger value as the scale of the environment is larger, and has a relationship of M₁>M₂>M₃.

In step S402, the local training unit 103 of each local device 10 trains the neural network by using the training data and trains (updates) the local model. When input to the local model is an input image x→ᵢⱼ and output from the local model is y→ᵢⱼ, the local model can be expressed by Equation (1).

→ᵢⱼ=f(x→ᵢⱼ, Θ→ᵢ) (1)

Equation (1) represents an input/output relationship when the i-th environment and the j-th training data are input. In this case, f represents a function of the neural network related to the local model, and Θ→ᵢⱼ represents a parameter set related to the i-th local model. Specifically, Θ→ᵢⱼ is configured of output layer parameters unique to each local model that does not share parameters with other local models, and a subset of model parameters of a convolution layer corresponding to at least a part of the global model. Note that the layer having the parameter unique to the local model is not limited to the output layer, and the first two layers including the input layer of each local model may be set as the layer having the parameter unique to each local model, or a part of the intermediate layer may be set as the layer having the parameter unique to each local model. Furthermore, in a case where each local model includes a normalization layer, the normalization layer may be the layer having parameters unique to the local model.

Lᵢⱼ=−t→ᵢⱼ^{T}ln(y→ᵢⱼ) (2)

Equation (2) represents a calculation formula for a training loss Liᵢⱼ when the i-th environment and the j-th training data are input. In this case, the calculation is performed using the cross-entropy. In each local device 10, for example, the average of the training losses of each of the plurality of input images related to the minibatch is calculated as a loss, and the value of the parameter set Θ→ᵢ of the neural network is updated by, for example, the back propagation method and the stochastic gradient descent method so as to minimize the loss.

In step S403, the local training unit 103 of each local device 10 determines whether or not the training of the local model is finished. For example, it may be determined that the training is finished when the parameters are updated a predetermined number of times, or it may be determined that the training is finished when each of the absolute values of the update amounts of the parameters or the sum of the absolute values becomes a constant value. Note that the determination as to whether or not the training is finished is not limited to the above-described example, and a commonly used training end condition may be used. When the training is finished, the process proceeds to step S404. When the training is not finished, the process returns to step S401 and the same process is repeated.

In step S404, the local selection unit 104 of each local device 10 selects the first parameter set to be transmitted to the server. Although it is assumed that parameters of layers excluding the output layer of each local model are selected as the first parameter set, parameters related to some convolution layers may be selected as the first parameter set.

In step S405, the local communication unit 105 of each local device 10 transmits information regarding the first parameter set to the server 11. The information regarding the first parameter set may be, for example, values of the parameters after an update, or an amount of change due to the update, for example, a difference between a value of a parameter before the update and a value of the parameter after the update. The first parameter set may include information indicating a correspondence relationship with a layer of the global model, such as an ID indicating which layer of the global model the first parameter set corresponds to.

Furthermore, the local communication unit 105 may compress and transmit data on the parameter set to be transmitted to the server 11. The data compression processing may be lossless compression or lossy compression. By compressing and transmitting the data, a communication amount and a communication band can be saved.

In step S406, the global communication unit 114 of the server 11 receives the information regarding the first parameter sets from each local device 10.

In step S407, the global update unit 112 of the server 11 integrates the received first parameter sets and updates the parameters of the global model to update the global model. The integration of the first parameter sets may be performed by, for example, calculating an average or a weighted average of the first parameter sets related to a layer common between the local models. As a method of updating the global model, for example, a moving average of a parameter related to the global model set before the update of the global model and each first parameter set may be used. As a result, the global model is updated.

In step S408, the global selection unit 113 of the server 11 selects the second parameter set to be transmitted to each local device 10 from the updated global model. That is, a parameter set that corresponds to each of the first parameter sets transmitted from each local device and is included in the entire global model, or a parameter set as a subset of the global model, is selected as the second parameter set.

In step S409, the global communication unit 114 of the server 11 transmits the information regarding the second parameter set corresponding to each first parameter set to the corresponding local device 10. The information regarding the second parameter sets may be associated with the information regarding the first parameter sets and may be values of the parameters after the update, or a change amount due to the update.

In step S410, the local communication unit 105 of each local device 10 receives the information regarding the second parameter set from the server 11.

In step S411, the local training unit 103 of each local device 10 reflects the received second parameter set as a parameter of the local model. Thereafter, the process returns to step S401 when the training processing of the local model is necessary, and the process may be repeated in the same manner. By repeatedly updating the parameters of the models between the local devices 10 and the server 11, so-called federated learning is executed.

An example of a correspondence relationship between the local model and the global model is described with reference to FIG. 5.

An example of the global model 50 that is the neural network included in the server 11 will be described. One cuboid of the global model 50 indicates a feature map after conversion is performed with a convolutional layer and optionally an activation layer. In this case, the convolution layer (and the activation layer) that outputs the feature map is also referred to as a conversion layer. The horizontal width is the number of channels of the feature map, and the height and the depth represent the size of the feature map. In the global model 50, three sets of feature map groups having different resolutions, in other words, three types of feature maps having different resolutions are obtained while three feature maps having the same size are treated as one set. In the example of FIG. 5, the global model 50 that has three processing stages for executing conversion processing three times by three conversion layers is represented. Specifically, the global model 50 includes the feature map group 501 obtained by each process of the first processing stage, the feature map group 502 obtained by each process of the second processing stage, and the feature map group 503 obtained by each process of the third processing stage. As a method of generating the feature maps having different resolutions, for example, the resolution is reduced by performing pooling processing or setting the stride of the convolution layer of the next stage to “2” or more every three times of conversion by the convolution layer (and the activation layer). Note that the next stage indicates the second processing stage when the first processing stage is focused on, and indicates the third processing stage when the second processing stage is focused on.

The local device 10A includes local data 51A and a local model 52A. The local device 10B includes local data 51B and a local model 52B. The local device 10C includes local data 51C and a local model 52C. In FIG. 5, one cuboid of each local model indicates a feature map similarly to the global model, and an ellipse is an output layer for performing conversion by a fully connected layer. The height of the output layer (the length of the ellipse) represents the number of channels, that is, the number of categories of the classification when a task is a classification task.

The local data 51 expresses the size and the number of data pieces of an input image, and the large-scale local data 51A has a larger size and a larger number of data pieces of the input image than the small-scale local data

The local model 52A used in the large-scale environment A has all conversion layers of the global model 50. In this case, the local model 52A includes 9 conversion layers and an output layer 53A. The local model 52A generates the same number of feature maps as those of the global model 50 by the conversion layers.

The local model 52B used in the medium-scale environment B has the first two conversion layers of each processing stage of the global model 50. In this case, the local model 52B includes 6 conversion layers and an output layer 53B. The local model 52B generates feature maps corresponding to the first two layers of each of the feature map groups 501 to 503 by the conversion layers.

The local model 52C used in the small-scale environment C has the first conversion layer of each processing stage of the global model 50. In this case, the local model 52C includes 3 conversion layers and an output layer 53C. The local model 52C generates feature maps corresponding to each of the first feature map of the feature map groups 501 to 503 by the conversion layers.

As described above, each of the local models 52A to 52C has the same size as the global model 50 that is a scalable network, or includes a subset of the global model 50.

Furthermore, since it is assumed that each of the output layers 53A, 53B, and 53C has a configuration different for each local model 52, the output layers are independently held by each local device 10.

In the local model 52A, the local selection unit 104 of the local device 10A can select, as the above-described first parameter set, parameters related to the 9 conversion layers of the entire local model 52A at the maximum. Similarly, in the local model 52B, the local selection unit 104 of the local device 10B can select, as the first parameter set, parameters related to the 2 conversion layers at each processing stage at the maximum, that is, the 6 conversion layers. In the local model 52C, the local selection unit 104 of the local device 10C can select, as the first parameter set, parameters related to the 1 conversion layer at each processing stage at the maximum, that is, the 3 conversion layers.

On the other hand, the global selection unit 113 of the server 11 selects, as the second parameter set, parameters of the conversion layers of the global model 50 corresponding to the conversion layers of the first parameter sets.

Note that each local model 52 is assumed to have a network structure of a fully convolutional neural network, and an image of an arbitrary image size can be input to each local model 52. That is, input images having different image sizes can be input to each local model 52. In addition, the output layer 53 in each local model 52 includes a global average pooling layer, a fully connected layer, and a softmax layer, and outputs an output vector y→ᵢⱼ having a number Mᵢⱼ of dimensions. Since the output vector y→ᵢⱼ is output from the softmax layer, the elements of the output vector y→ᵢⱼ are non-negative and the sum is 1.

In this manner, the size such as the number of layers of the network model trained as the local model 52 can be variably set according to the scale of the environment such as the size of the local data 51 and the computer scale.

In addition, it is assumed that the selection of the model size of the local model in each environment is set according to the inspection image size of each environment, but the selection is not limited thereto. For example, the larger the computer scale of each local device, the larger the model size of the local model may be set. In addition, for example, in a case where the processing speed is required according to the throughput required in each environment, the model size may be set small by giving priority to the speed. In addition, in a case where the processing speed is not required but the accuracy is required, priority may be given to the accuracy, and the model size may be set large. Further, the model size may be determined according to the communication environment of each environment. For example, when the communication speed between local device 10 and the server is high, the model size may be set large, and when the communication speed is low, the model size may be set small.

According to the first embodiment described above, the scalable neural network capable of adjusting the size of input data and the number of conversion layers is used as the global model existing in the server. On the other hand, each local device trains a local model adjusted according to its own computer resources and required specifications and including at least one conversion layer of the global model by using training data acquired in the environment of each local device. The parameters transmitted from each local device are integrated and updated as parameters of the scalable network on the server, and the second parameter sets related to the updated parameters are transmitted to the local devices. As a result, the federated learning can be flexibly implemented even when the scale and requirements of the environments in which the local devices are used are different.

### Second Embodiment

The second embodiment is different from the first embodiment in that a server 11 also executes training using training data.

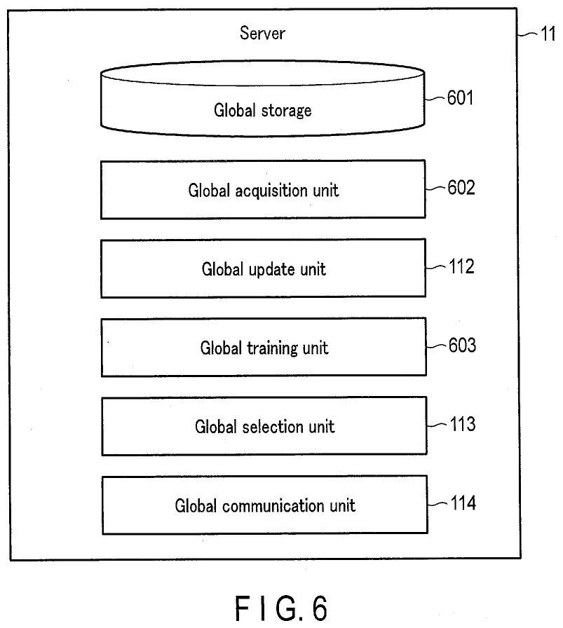

Next, the server 11 according to the second embodiment will be described with reference to a block diagram of FIG. 6.

The server 11 according to the second embodiment includes a global storage 601, a global acquisition unit 602, a global update unit 112, a global training unit 603, a global selection unit 113, and a global communication unit 114.

The global storage 601 stores a global data in addition to a global model. The global data does not depend on each environment, and is assumed to be data common to each environment, in other words, general and universal data. Specifically, when each environment is a hospital and local data is a medical image related to a patient in the hospital, a human body model not related to patient privacy or image data disclosed in a textbook may be used as the global data.

Note that the global model according to the second embodiment is different from that of the first embodiment in that the global model includes an output layer (not illustrated) since it is assumed that the global model is updated by the server 11 with training data based on the global data.

The global acquisition unit 602 acquires the training data by sampling the training data from the global data stored in the global storage 601.

The global training unit 603 uses the training data to train the global model. Regarding the training method, for example, a general method such as supervised learning using training data may be used, and thus a specific description thereof will be omitted here.

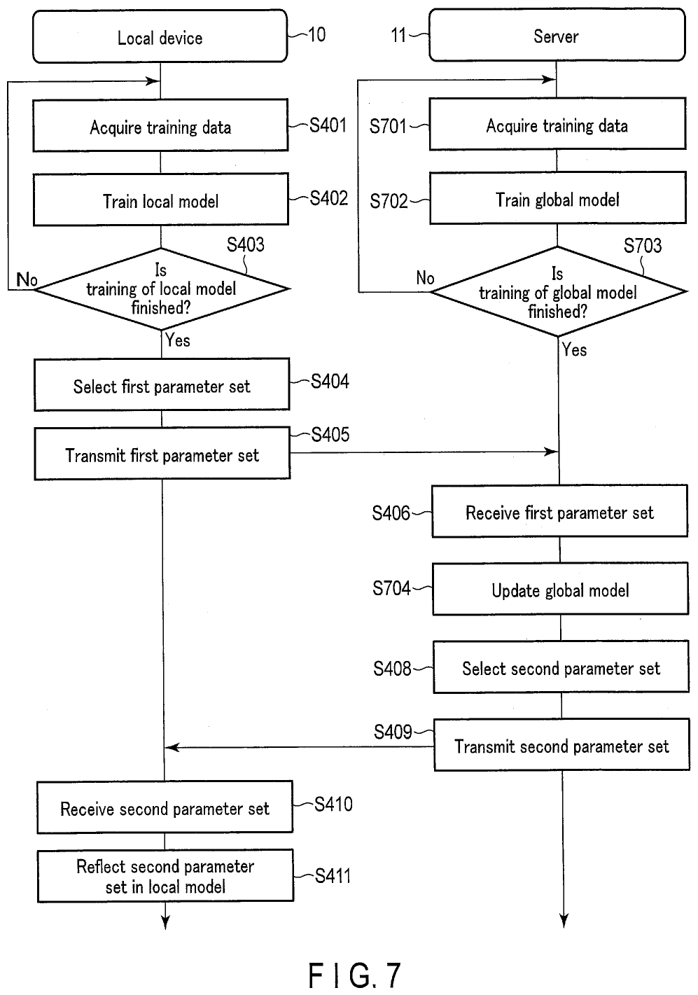

Next, a training process of a learning system according to the second embodiment will be described with reference to a flowchart of FIG. 7.

Note that processing (steps S401 to S405, step S410, and step S411) of the local device 10 is similar to that of the first embodiment, and therefore description thereof is omitted here.

In step S701, the global acquisition unit 602 acquires the training data by sampling the training data from the global data. Note that the data size (for example, the image size) of the global data held on the server 11, the number of types of target labels, and the like are desirably equal to or larger than the maximum number of local data from the viewpoint of integrating each environment, but the data size may be small, and the number of types of target labels may be small.

In step S702, the global training unit 603 trains the global model using the training data and updates parameters of the global model.

In step S703, the global training unit 603 determines whether or not the training of the global model is completed. When the training of the global model is completed, the process proceeds to step S406. When the training of the global model is not completed, the process returns to step S701 and the same process is repeated.

After the first parameter sets are received from each local device 10 in step S406, the global update unit 112 updates the global model in step S704. As a method of updating the global model, the global model may be updated using an average or a weighted average of values obtained by integrating the respective first parameter sets for the corresponding conversion layers and values of the parameters of the global model in the latest update, or a moving average of the parameters of the global model before the update, values obtained by integrating the respective first parameter sets, and values of the parameters of the global model in the latest update.

Furthermore, in the update of the global model, by increasing the weight of the parameter related to the update of the global model calculated by the global training unit 603, stable parameter integration processing can be implemented while reducing an effect specific to a local model in which a distribution bias or a bias is likely to occur. On the other hand, by reducing the weight of the parameter related to the update of the global model, the effect of the local model can be increased, and the parameter integration processing according to the update direction (update tendency) of each local model can be implemented.

Thereafter, similarly to the first embodiment, the second parameter set to be transmitted to each local device 10 may be selected from the updated global model, and the selected second parameter set may be transmitted to each local device 10.

According to the second embodiment described above, the server also trains the global model based on the superordinate concept of the local data or the global data on the contents common to the local data. As a result, parameter integration between the local models and the global model can be stably executed, and the federated learning can be stably implemented.

On the other hand, in the update of the global model, by adjusting the weight of the parameter related to the update of the global model, the effect of the update direction of each local model can be adjusted or can be reduced or increased.

### Third Embodiment

The third embodiment is different from the above-described embodiments in that a case for explaining the grounds of inference is presented to a local device.

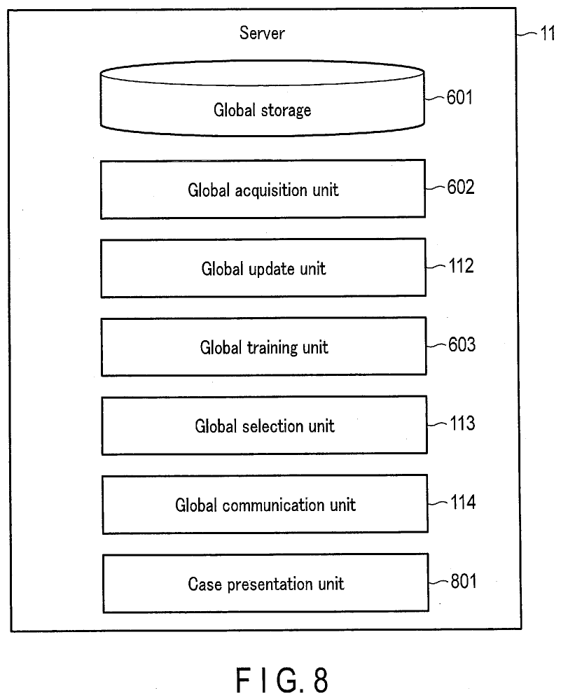

Next, a server 11 according to the third embodiment will be described with reference to a block diagram of FIG. 8.

The server 11 according to the third embodiment includes a global storage 601, a global acquisition unit 602, a global update unit 112, a global training unit 603, a global selection unit 113, a global communication unit 114, and a case presentation unit 801.

The case presentation unit 801 extracts global data that can be the basis of inference in the local model of the local device 10 in response to a request from the local device 10.

The global communication unit 114 transmits the global data extracted by the case presentation unit 801 to the local device 10 that has transmitted the request.

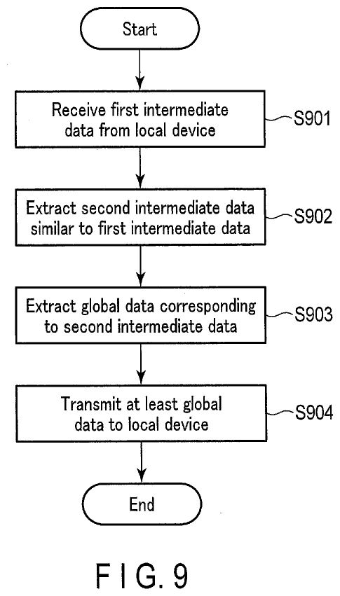

Next, a case presentation process of the server according to the third embodiment will be described with reference to a flowchart of FIG. 9. FIG. 9 illustrates the process of the server 11 alone.

In step S901, the global communication unit 114 receives, from the local device 10, a request related to data serving as the basis of inference and first intermediate data. The first intermediate data is, for example, a feature map in the intermediate layer of the local model. Specifically, the local device 10 transmits the feature map that is the output of the intermediate layer when the inference result is obtained. The feature map is desirably a feature map as close to the output layer as possible. Note that the request may be an instruction for simply requesting case presentation, or may include the inference result in addition to the instruction. Further, by receiving the intermediate data from the local device 10, it may be considered that a request related to case presentation is provided from the local device 10.

In step S902, the case presentation unit 801 extracts second intermediate data in the global model that is similar to the first intermediate data. In the method for extracting the second intermediate data, for example, the global storage 111 holds a feature map of each conversion layer (intermediate layer) for each training data in advance using the global model. The case presentation unit 801 compares the similarity between the feature map that is the first intermediate data and the feature maps stored in the global storage 111, and extracts a feature map having the maximum similarity as the second intermediate data.

Note that the case presentation unit 801 may extract a first feature amount by feature extraction processing on the feature map that is the first intermediate data, and select, as the second intermediate data, the feature map having the maximum similarity to a second feature amount extracted by the feature extraction processing from the feature maps held in the global storage 111.

In step S903, the case presentation unit 801 extracts global data that is training data corresponding to the second intermediate data.

In step S904, the global communication unit 114 transmits at least the global data to the local device 10 that has transmitted the request. Note that the second intermediate data extracted in step S902 may be transmitted to the local device 10. In general, in a case where the global data is compared with the feature maps, the feature maps are considered to be less readable. Therefore, in a case where the second intermediate data is transmitted to the local device 10, information regarding similarity to the first intermediate data may be transmitted together with the second intermediate data. Further, second intermediate data indicating a region particularly similar to the first intermediate data in the second intermediate data may be transmitted. For the designation of the similar region, for example, pattern matching processing may be executed between the first intermediate data and the second intermediate data, and a pixel region in which the similarity is equal to or greater than a threshold may be designated.

Furthermore, one feature map having the maximum similarity is not limited to the second intermediate data, and for example, a plurality of pieces of second intermediate data corresponding to a plurality of feature maps having similarity equal to or greater than a threshold and the similarity may be transmitted to the local device 10.

Note that, from the viewpoint of data confidentiality, the local device 10 may execute the feature extraction processing on the feature map in the local device 10 without transmitting the feature map as the first intermediate data, and transmit the generated first feature amount to the server 11. The server 11 may extract, as the second intermediate data, a feature map having the maximum similarity between the first feature amount and the second feature amount calculated by the above-described method.

According to the third embodiment described above, as case presentation for inference in the local devices, the server presents at least one of a feature map in the global model and the global data to the local devices. As a result, the case presentation serving as the basis of the inference is performed using the global data rich in the number of data pieces and variations, so that it is possible to implement a high level of comprehension even in a case where the number of pieces of training data and variations held in the environments of the local devices are small.

### Fourth Embodiment

The fourth embodiment is different from the above-described embodiments in that a change in an environment in which a local device is placed is determined in a server.

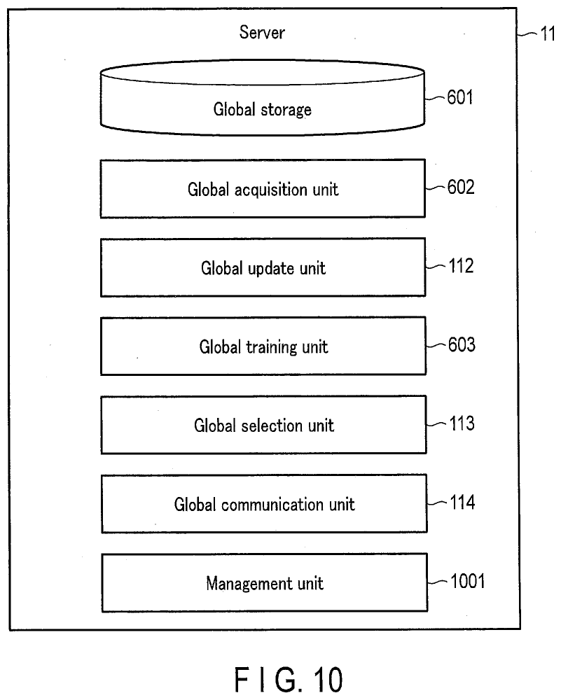

Next, a server 11 according to the fourth embodiment will be described with reference to a block diagram of FIG. 10.

The server 11 according to the fourth embodiment includes a global storage 601, a global acquisition unit 602, a global update unit 112, a global training unit 603, a global selection unit 113, a global communication unit 114, and a management unit 1001.

The management unit 1001 compares an update amount (referred to as a first update amount) based on parameters before and after training of the local model with an update amount (referred to as a second update amount) based on parameters before and after training of the global model, and determines that the environment of the corresponding local device has changed when a difference in update tendency between the first update amount and the second update amount is equal to or larger than a threshold.

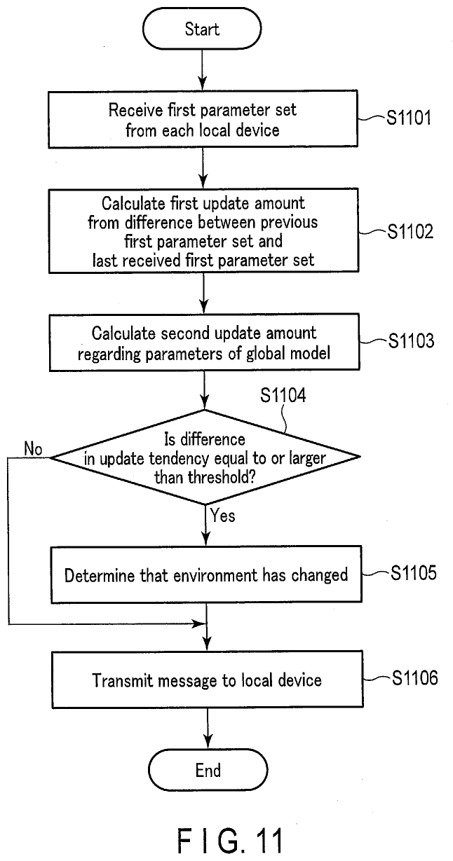

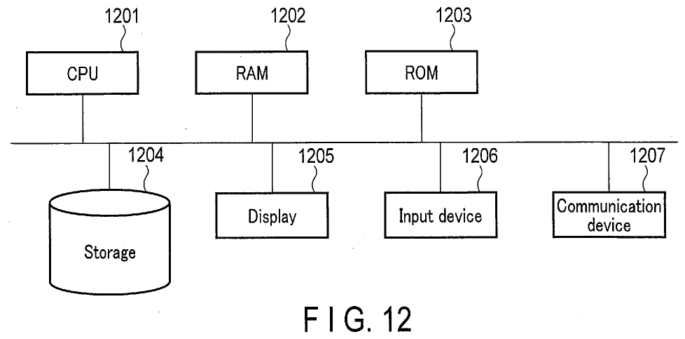

Next, a determination process of the server 11 according to the fourth embodiment will be described with reference to a flowchart of FIG. 11. FIG. 11 illustrates the process of the server 11 alone.

In step S1101, the global communication unit 114 receives information regarding a first parameter set from each local device 10.

In step S1102, the management unit 1001 calculates, as the first update amount, a difference between the previous first parameter set and the last received first parameter set. Further, the update tendency can be determined by referring to the positive or negative of the first update amount.

In step S1103, the management unit 1001 calculates the second update amount regarding the parameters of the global model. The second update amount is, for example, a difference between the second parameter set calculated in training by the global training unit 603 and the second parameter set before the training (before the update). Further, the update tendency can be determined by referring to the positive or negative of the second update amount.

In step S1104, the management unit 1001 compares the first update amount with the second update amount, and determines whether or not the difference in the update tendency is equal to or larger than the threshold. For example, when the difference between the first update amount and the second update amount is equal to or larger than a threshold, it is determined that the difference in the update tendency is equal to or larger than the threshold. When the difference in the update tendency is equal to or larger than the threshold, the process proceeds to step S1105. When the difference in the update tendency is smaller than the threshold, it is determined that there is no change in the environment of the local model, and the process ends.

In step S1105, the management unit 1001 determines that the difference in the update tendency indicates that the environment in which the local device 10 that has transmitted the first parameter set is placed has changed.

In step S1106, the management unit 1001 transmits a message indicating that the environment in which the local device is placed has changed to the local device 10 in the environment determined to have changed via the global communication unit 114.

Note that, in the local device 10 in the environment that has changed, there is a possibility that it is not necessary to reflect the second parameter set of the global model any more. Therefore, the management unit 1001 may transmit a message inquiring about whether or not to continue the federated learning to the local device. Note that the processing in step S1106 is not essential, and the server 11 may only grasp the determination result regarding the change in the environment.

Note that, in the above example, it is assumed that the determination of the difference in the update tendency is performed once in step S1104, but the processing from step S1101 to step S1104 illustrated in FIG. 11 may be repeated a plurality of times, and it may be determined that there is a change in the environment in a case where the number of times that the difference in the update tendency is the first threshold or more is a second threshold or more. That is, by determining that there is a change in the environment when the difference in the update tendency is detected a plurality of times, more stable determination processing can be implemented.

Furthermore, in the example of FIG. 11, an example is illustrated in which each local device 10 transmits the first parameter sets described in each of the first to third embodiments regardless of the first update amount, and the server 11 calculates the first update amount. Alternatively, each local device 10 may calculate the first update amount and transmit the calculated first update amount to the server 11. For example, the first parameter set transmitted to the server 11 last time may be held in the local storage 101, a difference from the newly calculated first parameter set may be calculated as the first update amount, and the first update amount may be transmitted to the server 11. The server 11 may continue to execute similar processing.

According to the fourth embodiment described above, the first update amount on the local device side is compared with the second update amount on the server side, and it is determined whether or not the update tendencies are different between the local device and the server. When the update tendencies are different, it may be determined that a change has occurred in the environment of the local device and the maintenance of the local model may be performed.

Note that, in the above-described embodiment, it is assumed that the layer structure of the local model included in each local device 10 is fixed, but the layer structure of the local model may be changed in a case where desired performance of the local model is required due to a change in training data, or in a case where the computer scale is improved due to the replacement of a PC including the local device, or the like.

For example, the local training unit 103 of the local device 10 calculates a performance index of the trained local model, for example, a reproduction rate (Recall) or a matching rate (Precision), and determines whether or not the performance index is equal to or less than a threshold. When the performance index is equal to or less than the threshold, desired performance is not obtained, and thus the local training unit 103 may build a local model in which the number of conversion layers corresponding to the scalable neural network that is the global model is increased. Specifically, the local model of the local device 10C may be scaled up to the local model of the local device 10B in which the number of conversion layers is increased.

To determine to which size the local model is scaled up, for example, the local device 10 sends a request for scaling up the local model to the server 11. The server 11 can grasp what the layer configuration of each local model is like from the first parameter sets. Therefore, the server 11 may transmit, for example, information regarding the layer configuration of the local model having a larger number of conversion layers than the local model that has transmitted the request and the corresponding second parameter set to the local device 10 that has transmitted the request. As a result, in the local device that has transmitted the request, the scale-up of the local model can be implemented.

FIG. 12 is a block diagram illustrating an example of a hardware configuration of the local device 10 and the server 11 according to each of the above-described embodiments.

The local device 10 and the server 11 includes a central processing unit (CPU) 1201, a random access memory (RAM) 1202, a read only memory (ROM) 1203, a storage 1204, a display device 1205, an input device 1206, and a communication device 1207, which are connected to each other by a bus.

The CPU 1201 is a processor that executes arithmetic processing, control processing, and the like according to a program. The CPU 1201 uses a predetermined area of the RAM 1202 as a work area to execute processing of each unit of the local device 10 and the server 11 described above in cooperation with programs stored in the ROM 1203, the storage 1204, and the like.

The RAM 1202 is a memory such as a synchronous dynamic random access memory (SDRAM). The RAM 1202 functions as a work area of the CPU 1201. The ROM 1203 is a memory that stores programs and various types of information in a non-rewritable manner.

The storage 1204 is a device that writes and reads data to and from a magnetic recording medium such as a hard disc drive (HDD), a semiconductor storage medium such as a flash memory, an optically recordable storage medium, or the like. The storage 1204 writes and reads data to and from the storage medium under the control of the CPU 1201.

The display device 1205 is a display device such as a liquid crystal display (LCD). The display device 1205 displays various types of information based on a display signal from the CPU 1201.

The input device 1206 is an input device such as a mouse and a keyboard. The input device 1206 receives information input by operation from the user as an instruction signal, and outputs the instruction signal to the CPU 1201.

The communication device 1207 communicates with an external device via a network in accordance with control from the CPU 1201.

The instructions indicated in the processing procedures described in the above-described embodiments can be executed based on a program that is software. By storing this program in advance and reading this program, a general-purpose computer system can obtain an effect similar to the effect of the control operation of the learning system (local devices and server) described above. The instructions described in the above-described embodiments are recorded in a magnetic disk (flexible disk, hard disk, or the like), an optical disc (CD-ROM, CD-R, CD-RW, DVD-ROM, DVD±R, DVD±RW, Blu-ray (registered trademark) disc, or the like), a semiconductor memory, or a recording medium similar thereto as a program that can be executed by a computer. The storage format may be any form as long as it is a recording medium readable by a computer or an embedded system. When the computer reads the program from the recording medium and causes the CPU to execute an instruction described in the program based on the program, it is possible to implement an operation similar to the control of the learning system (local devices and server) according to each of the above-described embodiments. Of course, when the computer acquires or reads the program, the program may be acquired or read via a network.

In addition, an operating system (OS) running on a computer, database management software, middleware (MW) such as a network, or the like may execute a part of each of the processes for implementing the present embodiment based on an instruction of the program installed in the computer or the embedded system from the recording medium.

Furthermore, the recording medium in the present embodiment is not limited to the medium independent of the computer or the embedded system, and includes a recording medium that downloads and stores or temporarily stores the program transmitted via a LAN, the Internet, or the like.

Furthermore, the number of recording media is not limited to one. Also in a case where the processing in the present embodiment is executed from a plurality of media, the media are included in the recording media in the present embodiment, and the configuration of the media may be any configuration.

Note that the computer or the embedded system in the present embodiment is for executing each of the processes in the present embodiment based on the program stored in the recording medium, and may have any configuration such as an apparatus including one of a personal computer, a microcomputer, and the like, a system in which a plurality of apparatuses is connected to a network, or the like.

In addition, the computer in the present embodiment is not limited to a personal computer, and includes an arithmetic processing apparatus, a microcomputer, and the like included in an information processing device, and collectively refers to a device and an apparatus that are capable of implementing the functions in the present embodiment by the program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A learning system comprising a plurality of local devices and a server, wherein
each of the local devices comprises a processor configured to:
train a local model by using local data;
select a first parameter set from a plurality of parameters related to the local model; and
transmit the first parameter set to the server, at least one of the local devices is different from other local devices in a size of the local model in accordance with a resolution of input data, and
the server comprises a processor configured to:
integrate first parameter sets acquired from the local devices and update a global model;
select each second parameter set corresponding to each of the first parameter sets from among a plurality of parameters related to the global model; and
transmit the second parameter set to a local device that has transmitted the corresponding first parameter set.

2. The system according to claim 1, wherein
the local model included in at least one of the local devices has a model structure different from model structures of the local models included in the other local devices, and
each of the local models included in the local devices corresponds to a layer structure of at least a part of the global model.

3. The system according to claim 2, wherein the model structures are determined by at least one of computer scale of the local devices on which the local models are mounted, a size of the local data, and a processing speed required in the local devices.

4. The system according to claim 1, wherein the global model has a size equal to or larger than the largest size among the sizes of the local models used by the local devices.

5. The system according to claim 1, wherein
the processor of the server is further configured to:
train the global model using global data; and
update the global model using a plurality of parameters related to the trained global model and each of the first parameter sets.

6. The system according to claim 1, wherein
the local models and the global model each include one or more intermediate layers,
the processor of the server is further configured to:
receive, from a first local device, first intermediate data that is output data from an intermediate layer of the local model;
extract second intermediate data that is output data from an intermediate layer of the global model and is similar to the first intermediate data;
extract global data corresponding to the second intermediate data; and
transmit the global data corresponding to the second intermediate data to the first local device.

7. The system according to claim 6, wherein the processor of the server transmits the second intermediate data to the first local device.

8. The system according to claim 1, wherein
the processor of the server is further configured to:
detect a difference in update tendency between each of the local models and the global model based on a first update amount based on the parameters before and after training of the local model and a second update amount regarding the parameters before and after updating of the global model; and
determine that an environment in which the local model is placed has changed in a case where the difference is equal to or larger than a threshold.

9. The system according to claim 1, wherein the second parameter set is a parameter set related to a model structure of the global model corresponding to a model structure of the local model to which a parameter selected as the first parameter set is applied.

10. A learning apparatus comprising a processor configured to:
receive a first parameter set that is a parameter when a local model included in each of a plurality of devices is trained;
integrate each of the received first parameter sets and update a global model;
select each second parameter set corresponding to each of the first parameter sets from among a plurality of parameters related to the global model; and
transmit the second parameter set to a device that has transmitted the corresponding first parameter set.

11. A learning method for a learning system including a plurality of local devices and a server, wherein
at each of the local devices,
training a local model by using local data;
selecting a first parameter set from a plurality of parameters related to the local model; and
transmitting the first parameter set to the server,
at least one of the local devices is different from other local devices in a size of the local model in accordance with a resolution of input data, and
at the server,
integrating first parameter sets acquired from the local devices and update a global model;
selecting each second parameter set corresponding to each of the first parameter sets from among a plurality of parameters related to the global model; and
transmitting the second parameter set to a local device that has transmitted the corresponding first parameter set.
